(19) United States
(12) Patent Application Publication
(10) Pub. No.: US 2012/0234363 A1
(43) Pub. Date: Sep. 20, 2012

(54) PHOTOMASK CLEANING APPARATUS

(75) Inventors: Jeong-Hee CHO, Hwaseong-si (KR); Sung-Jae Ryu, Seoul (KR); Hyung-Sin Kim, Hwaseong-si (KR); Sung-Tack Lim, Hwaseong-si (KR)

(73) Assignee: Samsung Electronics Co., Ltd., Suwon-si (KR)

(21) Appl. No.: 13/422,078

(22) Filed: Mar. 16, 2012

(30) Foreign Application Priority Data
Mar. 17, 2011 (KR) 10-2011-0024048

(51) Int. Cl. B08B 3/08; B08B 5/00; B08B 3/02

(52) U.S. Cl. 134/99.1; 134/103.2

(57) ABSTRACT

Provided is a photomask cleaning apparatus. The apparatus may include a photomask chuck, a cleaning arm and a nozzle set. The nozzle set may be installed in an end portion of the cleaning arm. The nozzle set may include a first nozzle and a second nozzle. The first nozzle and the second nozzle may be a bar-type shape and parallel to each other.

### CROSS-REFERENCE TO RELATED APPLICATIONS

This application claims priority under 35 U.S.C. §119 to Korean Patent Application No. 10-2011-0024048 filed on Mar. 17, 2011, the disclosure of which is hereby incorporated by reference in its entirety.

### BACKGROUND

1. Field

Example embodiments of the present general inventive concept relate to a photomask cleaning apparatus and a method of cleaning a photomask using the same.

2. Description of the Related Art

Generally, a pellicle may be mounted on a photomask in order to protect optical patterns in the photomask. The pellicle may be attachable and detachable from the photomask. During cleaning of the photomask, the pellicle may be separated from the photomask. However, after the separation of the pellicle from the photomask, glue or an adhesive of the pellicle may remain on the photomask. Hence, there is a growing need for securely removing the glue or adhesive from the photomask without any damage to the optical patterns of the photomask during the removal of the glue or adhesive.

### SUMMARY

Example embodiments of the present general inventive concept provide a photomask cleaning apparatus suitable to clean only a specific region of a photomask while cleaning the photomask.

Example embodiments of the present general inventive concept further provide a photomask cleaning apparatus suitable to prevent chemicals of a cleaning solution from approaching a specific region of a photomask while cleaning the photomask.

Example embodiments of the present general inventive concept further provide a photomask cleaning apparatus suitable to flow a cleaning solution into a specific direction while cleaning the photomask.

Example embodiments of the present general inventive concept further still provide a method of cleaning a photomask using a photomask cleaning apparatus.

Other exemplary embodiments of the present general inventive concept are not limited to the foregoing exemplary embodiments and are fully understood by those skilled in the art to which the inventive concept belongs, through the following illustration.

In accordance with exemplary embodiments of the present general inventive concept, a photomask cleaning apparatus may comprise a photomask chuck, a cleaning arm and a nozzle set. The nozzle set may be installed in an end portion of the cleaning arm. The nozzle set may include at least first and second nozzles. The at least first and second nozzles may be a bar-type shape and parallel to each other.

A first nozzle may include a first outer case and a first inner tube, and a second nozzle may include a second outer case and a second inner tube.

The first outer case may have a first slit thereon.

The first outer case may have at least two guiders in a lower portion thereof, and the at least two guiders may define the first slit.

Each of the first inner tube and the second inner tube may have a plurality of holes thereon.

Each of the holes may range between 0.5 mm and 2.0 mm in diameter, and the distance between the holes may range between 1.0 mm and 3.0 mm.

The diameter of each of the holes in the first nozzle may be smaller than that of each of the holes in the second nozzle.

A first nozzle may spray a liquid.

The liquid may include at least one of a sulfuric acid solution, a hydrogen peroxide solution, an ammonia solution, a nitric acid solution, a hydrofluoric acid solution, a hydrochloric acid solution, an acetone, alcohol, a solvent, and water.

A second nozzle may spray a gas (e.g., air).

A first nozzle may range between, for example, 127 mm and 152 mm in length.

The first nozzle may be greater in length than a second nozzle.

The photomask cleaning apparatus may further comprise a fluid-supplying path supplying the nozzle set with a fluid.

The fluid-supplying path may include a first fluid-supplying path and a second fluid-supplying path. The first fluid-supplying path and the second fluid-supplying path are connected to a first nozzle and a second nozzle, respectively.

The first fluid-supplying path may supply a liquid for the first nozzle, and the second fluid-supplying path may supply a gas (e.g., air) for the second nozzle.

The fluid-supplying path may be installed in the interior of the cleaning arm.

A first nozzle may be located farther than a second nozzle from the photomask chuck.

The second nozzle may be inclined with respect to a surface of the photomask chuck.

In accordance with exemplary embodiments, a photomask cleaning apparatus may comprise a photomask chuck, a cleaning arm and a nozzle set. The nozzle set may be installed in an end portion of the cleaning arm. The nozzle set may include at least two nozzles each having a liquid-spraying nozzle and a gas-spraying nozzle. The liquid-spraying nozzle and the air-spraying nozzle may be parallel to each other and inclined with respect to the photomask chuck.

Each of the liquid-spraying nozzle and the air-spraying nozzle may include an inner tube and an outer case. The inner tube may include a plurality of holes. The outer case may include guiders in a lower portion thereof. The guiders may define a slit therebetween.

In accordance with exemplary embodiments of the present general inventive concept, a photomask cleaning apparatus configured to clean a surface of a photomask may include a cleaning arm and a first nozzle set including at least a first nozzle and a second nozzle installed in an end portion of the cleaning arm.

The first and second nozzles of the first nozzle may be bar-type shaped and substantially parallel to each other.

Further, the first nozzle may include a first outer case having at least two guiders defining a first slit therein and a first inner tube having a plurality of holes formed therein. Similarly, the second nozzle may include a second outer case having at least two guiders defining a second slit therein and a second inner tube having a plurality of holes formed therein.

The first and second nozzles may be inclined with respect to the surface of a photomask. That is, one or both of the first and second nozzles may be inclined with respect to the surface of the photomask.

The photomask cleaning apparatus may further include a second nozzle set including at least a third nozzle and a fourth nozzle installed in the end portion of the cleaning arm; a third nozzle set including at least a fifth nozzle and a sixth nozzle installed in the end portion of the cleaning arm; and a fourth nozzle set including at least a seventh nozzle and a eighth nozzle installed in the end portion of the cleaning arm. Further, the first nozzle set may be substantially parallel to the second nozzle set and the third nozzle set may be substantially parallel to the fourth nozzle set. Moreover, the first and second nozzle sets may be substantially perpendicular to the third and fourth nozzle sets.

Additional features and utilities of the present general inventive concept will be set forth in part in the description which follows and, in part, will be obvious from the description, or may be learned by practice of the general inventive concept.

### BRIEF DESCRIPTION OF THE DRAWINGS

The foregoing and other features and advantages of the present general inventive concept will be apparent from the more particular description of example embodiments of the present general inventive concept, as illustrated in the accompanying drawings in which like reference characters refer to the same parts throughout the different views. The drawings are not necessarily to scale, emphasis instead being placed upon illustrating the principles of the present general inventive concept. In the drawings:

These and/or other features and utilities of the present general inventive concept will become apparent and more readily appreciated from the following description of the embodiments, taken in conjunction with the accompanying drawings of which:

FIG. 1 is a perspective view showing a photomask cleaning apparatus according to example embodiments of the present general inventive concept.

FIG. 2 is a perspective view showing a photomask cleaning apparatus according to example embodiments of the present general inventive concept.

FIG. 3 is a perspective view showing a photomask cleaning apparatus according to example embodiments of the present general inventive concept.

FIG. 4 is a perspective view showing a photomask cleaning apparatus according to example embodiments of the present general inventive concept.

FIGS. 5a and 5b are perspective views showing a combination of a cleaning arm and a nozzle set according to example embodiments of the present general inventive concept.

FIGS. 6a to 8b are perspective views showing nozzle sets according to example embodiments of the present general inventive concept.

FIGS. 9a and 9b are perspective views showing a cleaning arm and a nozzle set according to modified example embodiments of the present general inventive concept.

FIGS. 10a and 10b are perspective views showing a cleaning arm and a nozzle set according to modified example embodiments of the present general inventive concept.

FIGS. 11a to 11c are schematic views illustrating a method of cleaning a photomask using a photomask cleaning apparatus according to example embodiments of the present general inventive concept.

### DETAILED DESCRIPTION OF THE EXEMPLARY EMBODIMENTS

Various example embodiments will now be described more fully with reference to the accompanying drawings in which some example embodiments are shown. However, specific structural and functional details disclosed herein are merely representative for purposes of describing example embodiments. Thus, the present general inventive concept may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the present general inventive concept.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” with another element, it can be directly connected, or coupled, to the other element or intervening elements may be present. In contrast, if an element is referred to as being “directly connected” or “directly coupled” with another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of exemplary embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In order to more specifically describe example embodiments, various features and utilities will be described in detail with reference to the attached drawings. However, the present general inventive concept is not limited to example embodiments described.

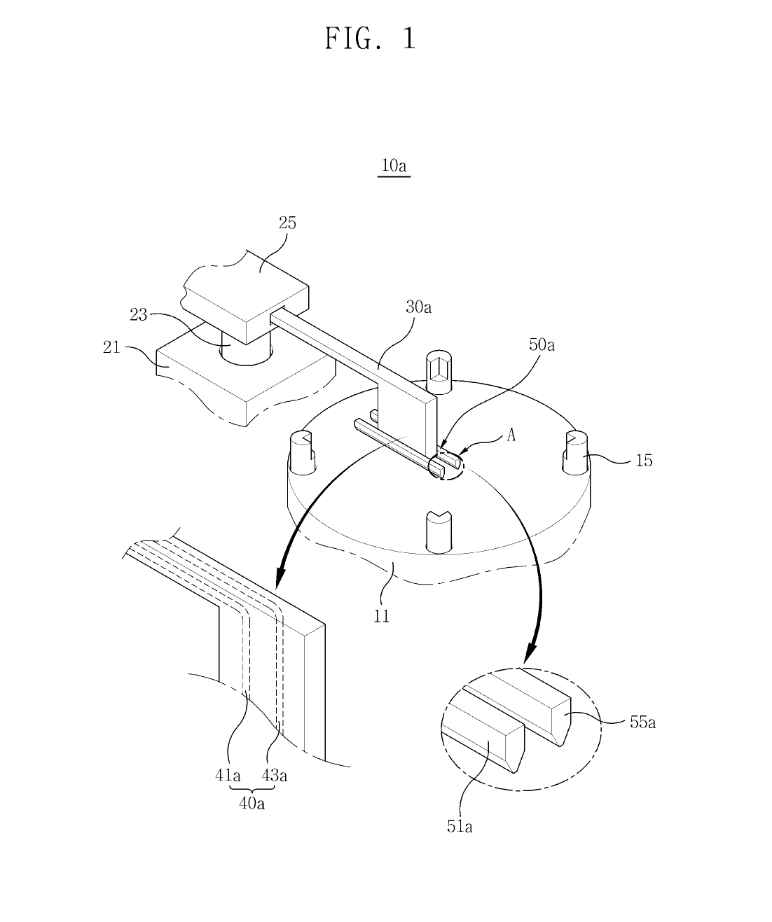

FIG. 1 is a perspective view showing a photomask cleaning apparatus according to example embodiments of the present general inventive concept.

Referring to FIG. 1, a photomask cleaning apparatus 10a according to example embodiments of the present general inventive concept may comprise a photomask chuck 11, a cleaning arm 30a and a nozzle set 50a. The photomask chuck 11 may rotate, may mount a photomask (not shown) thereon, and may have more than four fingers 15. The fingers 15 may protrude from a top surface of the photomask chuck 11. The fingers 15 may have grooves downwardly from an upper portion of the fingers 15 to a lower portion thereof in order to support and fix the photomask.

The cleaning arm 30a may be combined with and/or fixed to a header 25. The length of a protruding portion of the cleaning arm 30a from the header 25 may be adjusted. The cleaning arm 30a may be stainless steel or stainless alloy steel. The cleaning arm 30a may have a fluid-supplying path 40a therein that may be inserted or installed in the interior of the cleaning arm 30a. The fluid-supplying path 40a may provide a liquid and air to the nozzle sets 50a.

The fluid-supplying path 40a may comprise a first fluid-supplying path 41a and a second fluid-supplying path 43a. The first and second fluid-supplying paths 41a and 43a may provide different fluids from each other. The fluid-supplying path 40a may be hollow spaces in the cleaning arm 30a as shown in a partial detail view of the cleaning arm 30a, or may be separate tubes different from the cleaning arm 30a. For example, the fluid-supplying path 40a may be Teflon such as polytetrafluoroethylene. The header 25 may be supported by a supporting part 23 that may move up and down, as well as may rotate. The supporting part 23 may be combined with and/or fixed to a base part 21.

The nozzle set 50a may be installed in an end portion of the cleaning arm 30a. The nozzle set 50a may comprise at least two first and second nozzles 51a and 55a. The first nozzle 51a may spray the liquid on the photomask through the cleaning arm 30a, and the second nozzle 55a may spray air on the photomask through the cleaning arm 30a. The respective first and second nozzles 51a and 55a may have a bar-type outward shape as shown in an enlarged view of A region. The respective first and second nozzles 51a and 55a may have a slit on the bar-type outward shape.

The first and second nozzles 51a and 55a may be parallel with respect to each other. A spray angle of each of the first and second nozzles 51a and 55a may be freely adjusted with respect to the cleaning arm 30a. The nozzle set 50a may be attachable and detachable from the cleaning arm 30a. The first and second nozzles 51a and 55a may be connected to the first fluid-supplying path 41a and the second fluid-supplying path 43a, respectively. The length of each of the first and second nozzles 51a and 55a may be greater than a side of a pattern region in the photomask.

For example, the length of each of the first and second nozzles 51a and 55a may be more than 5 inches (=127 mm). Further, the length of each of the first and second nozzles 51a and 55a may not be excessively greater than a side of the photomask, and may be for example, 6 inches (=152 mm). In exemplary embodiments, the length of each of the first and second nozzles 51a and 55a is, for example, about 150 mm. The second nozzle 55a may have a greater length than the first nozzle 51a.

The liquid may comprise a cleaning solution, such as a sulfuric acid solution, hydrogen peroxide solution, an ammonia solution, a nitric acid solution, a hydrofluoric acid solution, a hydrochloric acid solution, an acetone, alcohol, a solvent, water or other chemicals for cleaning. The air may comprise a nitrogen gas, an oxygen gas, a carbon dioxide gas or an inert gas.

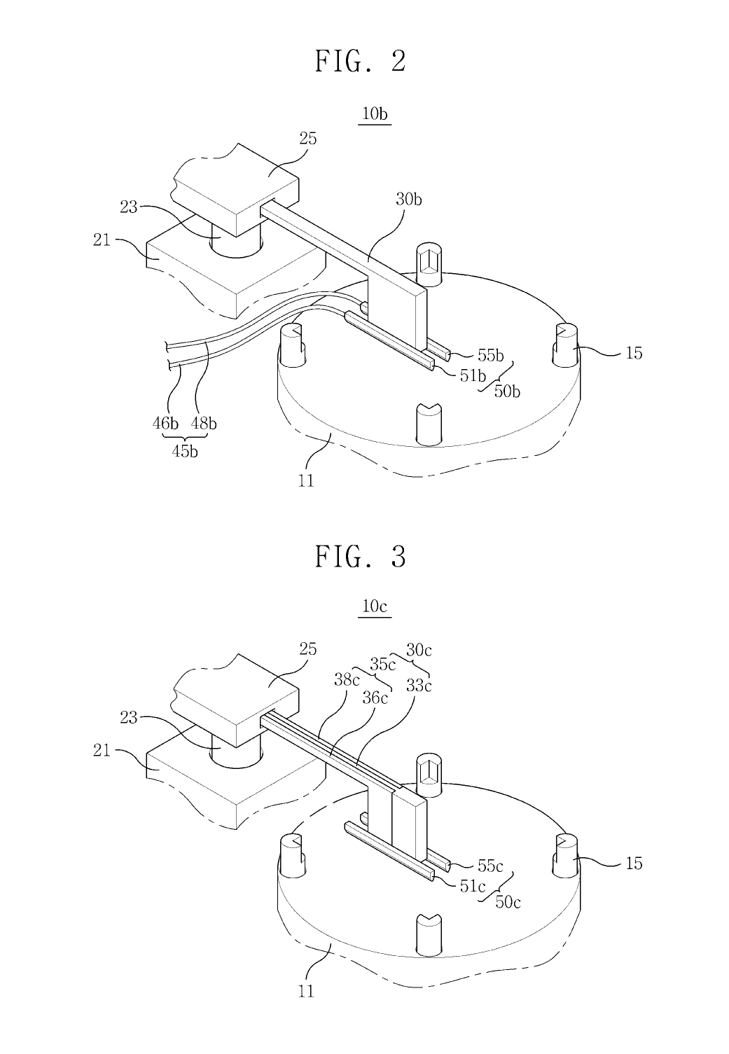

FIG. 2 is a perspective view showing a photomask cleaning apparatus according to example embodiments of the inventive concept.

Referring to FIG. 2, a photomask cleaning apparatus 10b according to example embodiments of the inventive concept may comprise a photomask chuck 11, a cleaning arm 30b, a nozzle set 50b and a fluid-supplying part 45b. The nozzle set 50b may comprise a first nozzle 51b and a second nozzle 55b. The fluid-supplying part 45b may comprise a first fluid-supplying tube 46b and a second fluid-supplying tube 48b. The fluid-supplying and second-supplying tubes 46b and 48b may be connected to the first and second nozzles 51b and 55b, respectively.

The first fluid-supplying tube 46b may be configured to be one with the second fluid-supplying tube 48b, or be attachable to and detachable from the second fluid-supplying tube 48b. The fluid-supplying part 45b may be combined with the cleaning arm 30b. For example, the fluid-supplying part 45b may be inserted into the cleaning arm 30b, or connected to the exterior of the cleaning arm 30. The fluid-supplying part 45b may be formed of, for example, Teflon.

FIG. 3 is a perspective view showing a photomask cleaning apparatus according to an exemplary embodiment of the inventive concept.

Referring to FIG. 3, a photomask cleaning apparatus 10c may comprise a photomask chuck 11, a cleaning arm 30c and a nozzle set 50c. The cleaning arm 30c may comprise a supporting arm 33c and a supplying arm 35c, and the supporting arm 33c may be combined with the supplying arm 35c. The supplying arm 35c may be attachable to, and detachable from, the supporting arm 33c. The supporting arm 33c may support the nozzle set 50c and the supplying arm 35c.

The supplying arm 35c may comprise a first supplying arm 36c and a second supplying arm 38c. The first supplying arm 36c may have a path to supply a liquid and the second supplying arm 38c may have a path to supply a gas (e.g., air) (see also FIG. 1). The nozzle set 50c may comprise a first nozzle 51c and a second nozzle 55c. The first nozzle 51c may be combined with and supported by the supporting arm 33c. The first nozzle 51c may receive the liquid through the first supplying arm 36c.

The second nozzle 55c may be combined with, and supported by, the supporting arm 33c and may receive the gas (e.g., air) through the second supplying arm 38c. The supporting arm 33c and the supplying arm 35c may be made separately and may be mechanically combined with each other.

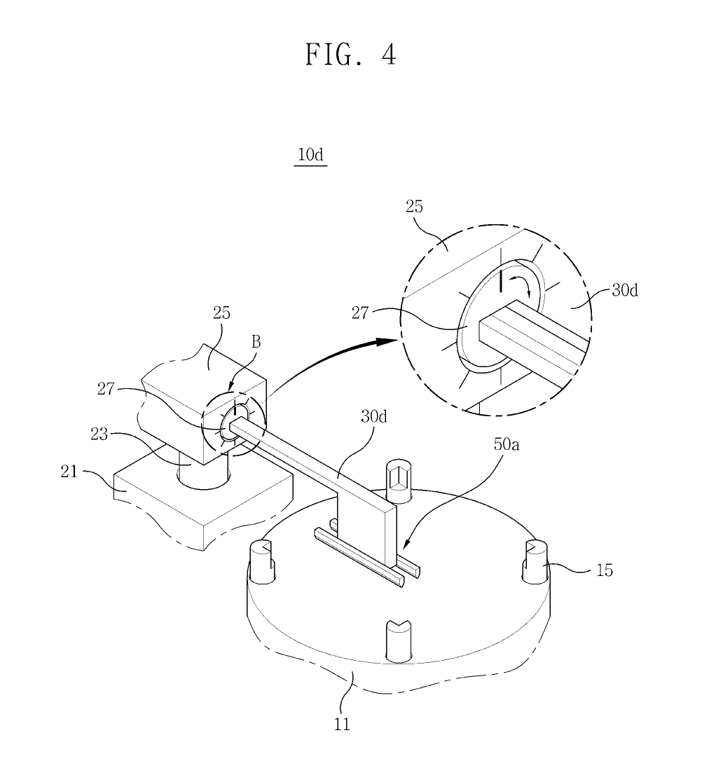

FIG. 4 is a perspective view showing a photomask cleaning apparatus according to an exemplary embodiment of the inventive concept.

Referring to FIG. 4, a photomask cleaning apparatus 10d may further comprise a swing part 27 in a header 25 thereof. The swing part 27 may rotate a cleaning arm 30d along a direction of an arrow as shown in an enlarged view of region B. To this end, the header 25 may comprise a bearing, a sliding part, a driving gear and/or a driving belt to rotate the cleaning arm 30d with respect to the header 25. A rotation angle of the swing part 27 may be, for example, equal to and less than 45° in left and right directions around the cleaning arm 30d. However, the rotation angle is not limited to above example and may be greater than 45° in left and right directions around the cleaning arm 30d.

The greater the rotation angle, the more complicated the structure of the swing part 27 becomes. Thus, in this exemplary embodiment, the rotation angle of the swing part is set to be equal to and less than 45° so that the photomask cleaning apparatus 10d may have a less complex construction.

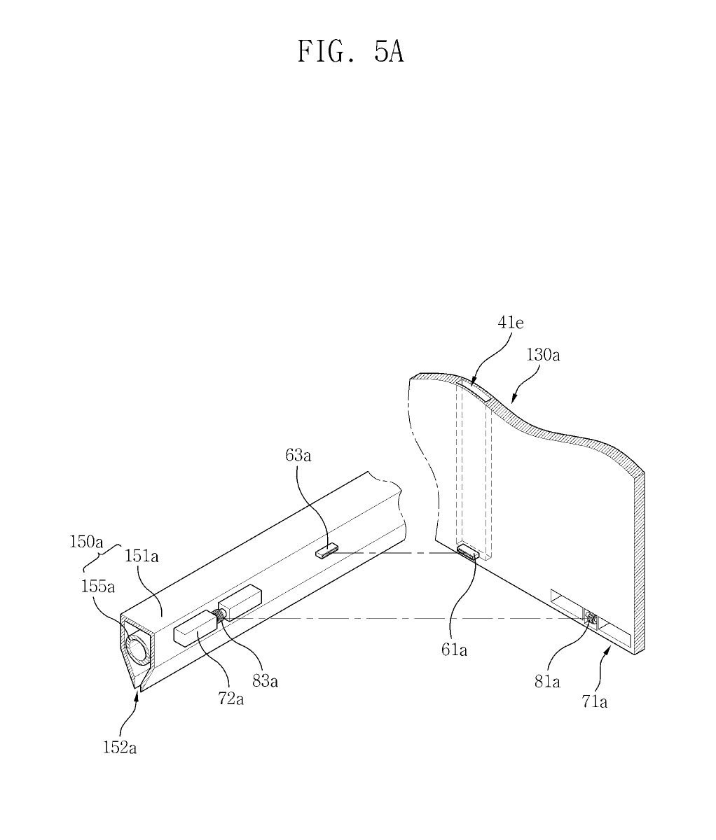

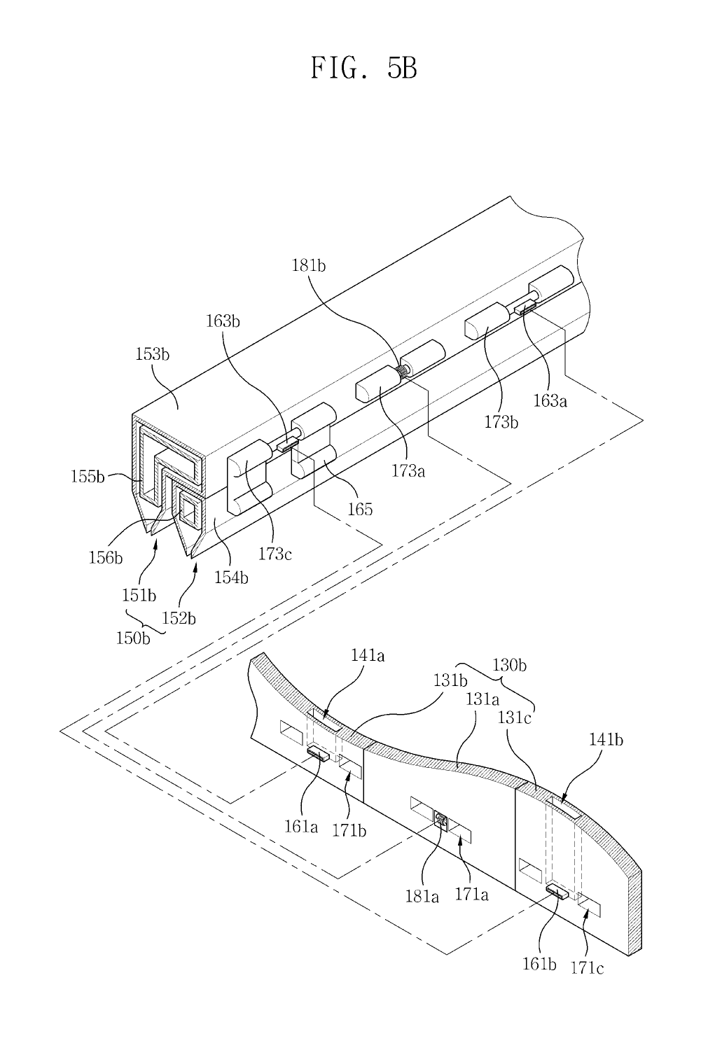

FIGS. 5A and 5B are perspective views showing a combination of a cleaning arm and a nozzle set according to an exemplary embodiment of the present general inventive concept.

Referring to FIG. 5A, a cleaning arm 130a and a nozzle set 150a may be attachable to, and detachable from, each other. The cleaning arm 130a may comprise a fluid-supplying path 41e in the interior thereof and a fluid-supplying inlet 61a and a first nozzle coupling portion 71a. The fluid-supplying inlet 61a may transfer a fluid from the fluid-supplying path 41e to the nozzle set 150a.

The first nozzle coupling portion 71a may mechanically combine the cleaning arm 130a with the nozzle set 150a. The first nozzle coupling portion 71a may comprise a first gear 81a in a driving part of the cleaning arm 130a. The nozzle set 150a may comprise a fluid-receiving inlet 63a. The fluid-receiving inlet 63a may be connected to the fluid-supplying inlet 61a. The fluid-receiving inlet 63a may transfer the fluid from the fluid-supplying inlet 61a to the nozzle set 150a.

The nozzle set 150a may comprise a second coupling portion 72a that may be mechanically combined with first nozzle coupling portion 71a, or may act as a subsidiary function in combining with the cleaning arm 130a. As shown in FIG. 5A, the second coupling portion 72a may be inserted into the first coupling portion 71a. Alternatively, or in addition to the above arrangement, the first coupling portion 71a may be combined with the second coupling portion 72a through a bolt, a pin or the like.

The nozzle set 150a may comprise a second gear 83a on the second coupling portion 72a that may be engaged with the first gear 81a. The first and second gears 81a and 83a may adjust the fluid-spraying angle and fluid-spraying range of the nozzle set 150a with respect to the cleaning arm 130a. The first and second gears 81a and 83a may be substituted with a hinge or the like. Together with the engagement of the first and second gears 81a and 83a, a variety of rotation means may be applied to the cleaning arm 130a and/or the nozzle set 150a.

The nozzle set 150a may comprise an outer nozzle 151a and an inner nozzle 155a. The outer nozzle 151a may be a bar-type hollow case, which has a slit 152a in a lower portion thereof. The outer nozzle 151a may protect the inner nozzle 155a from physical or chemical damage, and may define the spraying range and spraying shape of the fluid. The inner nozzle 155a may be a hose or a tube having a plurality of holes.

The inner nozzle 155a may be located in the interior of the outer nozzle 151a and may transfer the fluid to the outer nozzle 151a. The outer nozzle 151a may exhaust the fluid toward the exterior and the outer and inner nozzles 151a and 155a may be formed of, for example, Teflon. Further, the outer nozzle 151a and the inner nozzle 155a may be formed as a single unit or as separate units combined together.

Referring to FIG. 5B, a cleaning arm 130b and a nozzle set 150b may be attachable to, and detachable from, each other. The cleaning arm 130b may comprise a supporting arm 131a, a first fluid-supplying arm 131b and a second fluid-supplying arm 131c. The supporting arm 131a may comprise a first coupling portion 171a and a first gear 181. The first coupling portion 171a may be combined with the nozzle set 150b.

The first fluid-supplying arm 131b may comprise a first fluid-supplying path 141a, a first fluid-supplying inlet 161a and/or a second coupling portion 171b. The second fluid-supplying arm 131c may comprise a second fluid-supplying path 141b, a second fluid-supplying inlet 161b and/or a third coupling portion 171c. The nozzle set 150b may comprise a first fluid nozzle 151b and a second fluid nozzle 152b. The first fluid nozzle 151b may comprise an outer case 153b and an inner tube 155b. The second fluid nozzle 152b may comprise an outer case 154b and an inner tube 156b.

The nozzle set 150b may comprise a fourth coupling portion 173a, a fifth coupling portion 173b, a sixth coupling portion 173c, a first fluid-receiving inlet 163a, and/or a second fluid-receiving inlet 163b. The fourth coupling portion 173a may have a second gear 181b thereon. The second fluid-receiving inlet 163b may have a side tube 165, which may transfer fluid to the second fluid nozzle 152b.

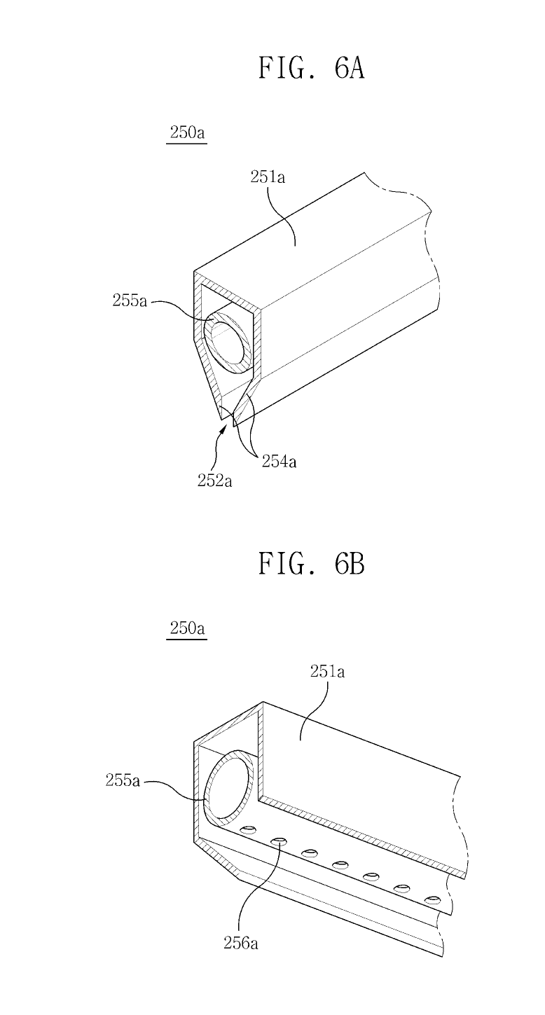

FIGS. 6A to 8B are perspective views showing nozzle sets according to exemplary embodiments of the present general inventive concept.

Referring to FIG. 6A, a nozzle set 250a may comprise an outer nozzle 251a and an inner nozzle 255a. The outer nozzle 251a may comprise a hollow case having a slit 252a, which may be located between two guiders 254a of the outer nozzle 251a. The guiders 254a may define the spraying range and spraying shape of a fluid.

For example, the guiders 254a may define a slit 252a therebetween and may spray the fluid in a straight line or a in bar type shape along a length of the outer nozzle 251a regardless of the shape of inner nozzle 255a.

Referring to FIG. 6B, the inner nozzle 255a may comprise a plurality of holes 256a in a lower portion thereof. The respective holes 256a may range between 0.5 mm and 2.0 mm in diameter. The holes 256a may be spaced between 1.0 mm and 3.0 mm from one another. The holes 256a may be arranged, for example, along a line, in a zigzag type, in a mesh type, along a pair of parallel lines or a various other arrangements.

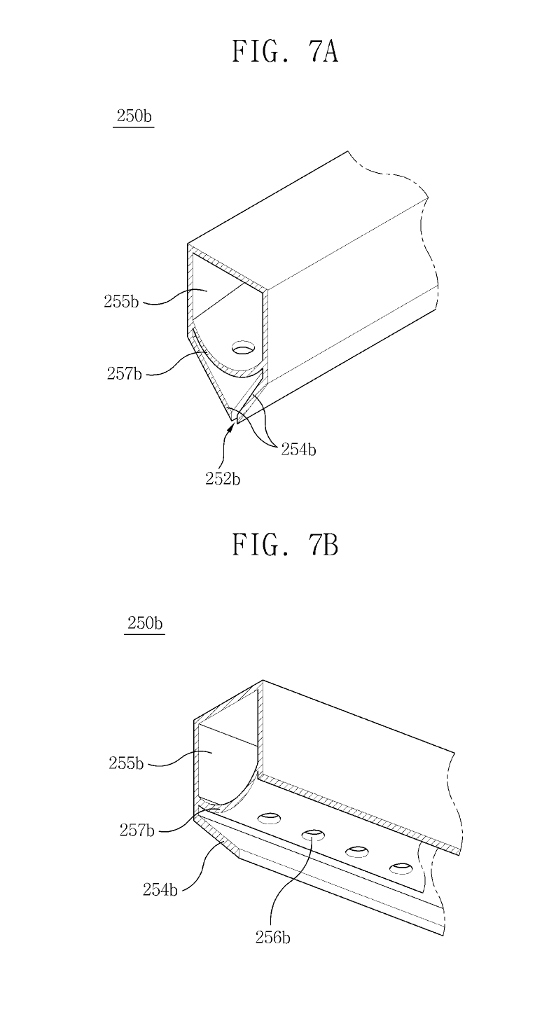

Referring to FIG. 7A, a nozzle set 250b according to an exemplary embodiment of the present general inventive concept may be configured to have an inner space 255b, an inner partition 257b, a slit 252b and guiders 254b. The inner partition 257b may comprise a plurality of holes 256b as shown in FIG. 7B. The nozzle set 250b is a modification of the nozzle set 250a of FIGS. 6A and 6B in that the outer nozzle 251a and the inner nozzle 255a of the nozzle set 250a of FIGS. 6A and 6B are formed of a single unit.

Also, the inner partition 257b of the nozzle set 250b of FIG. 7A is assumed to install in the interior of the nozzle set 250b. Further, the guiders 254b of FIG. 7A are assumed to install in the exterior similar to the arrangement of the outer nozzle 251a of FIG. 6A with respect to the inner nozzle 255a of FIGS. 6A and 6B for defining the slit 252b of FIG. 7A.

Referring to FIG. 7B, the holes 256b of the inner partition 257b may expose the inner space 255b to the guiders 254b or the slit 252b of FIG. 7A. The holes 256b may be understood in detail by referring to FIG. 6B.

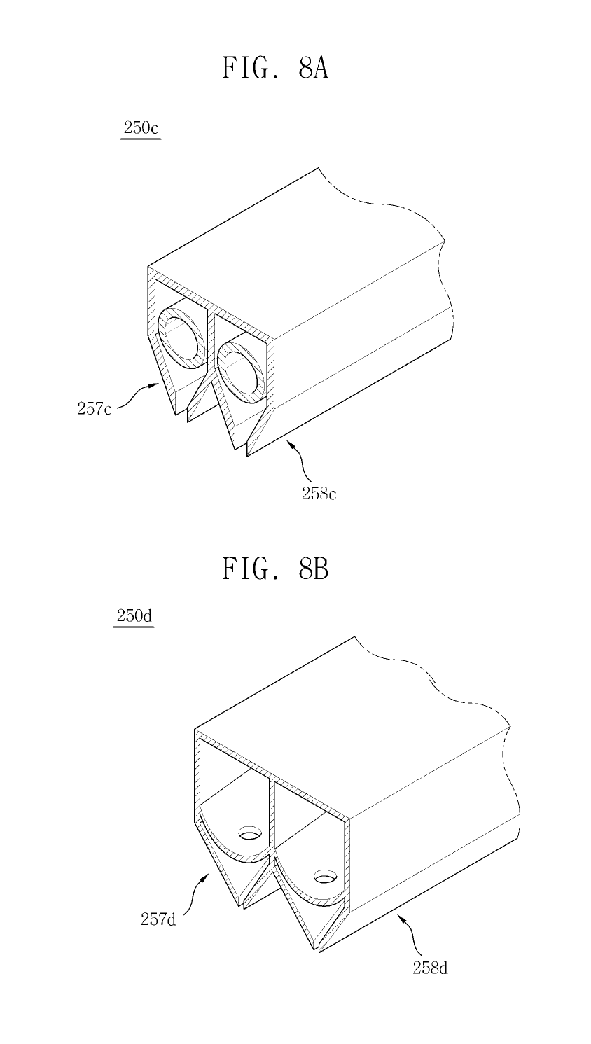

Referring to FIG. 8A, a nozzle set 250c according to another exemplary embodiment of the present general inventive concept may comprise a first nozzle 257c and a second nozzle 258c. The first nozzle 257c and the second nozzle 258c may be formed as a single unit. The first nozzle 257c and the second nozzle 258c may be understood in detail by referring to FIGS. 6A and 6B. The diameter of each of holes in the first nozzle 257c may be equal to or different from the diameter of each of holes in the second nozzle 258c.

Referring to FIG. 8B, a nozzle set 250d according to another exemplary embodiment of the present general inventive concept may comprise a first nozzle 257d and a second nozzle 258d. The first nozzle 257d and the second nozzle 258d may be formed as a single unit. The first nozzle 257d and the second nozzle 258d may be understood in detail by referring to FIGS. 7A and 7B. The diameter of each of holes in the first nozzle 257d may be equal to or different from the diameter of each of holes in the second nozzle 258d.

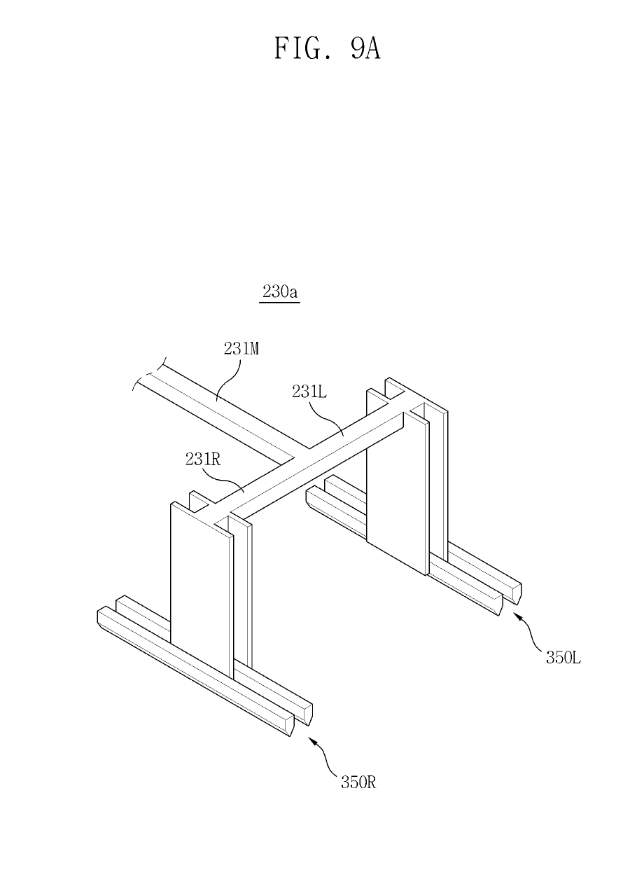

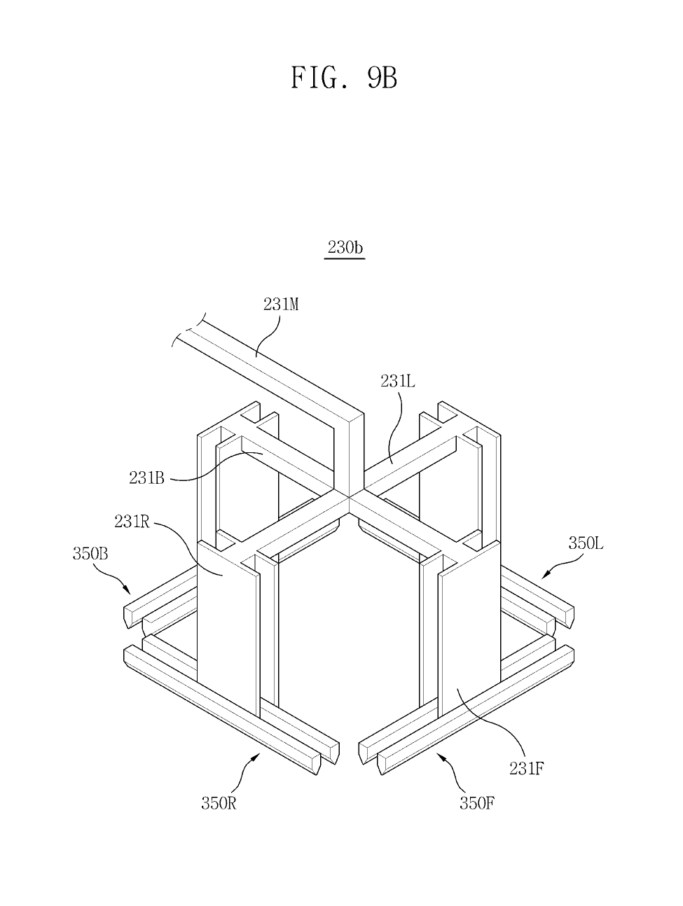

FIGS. 9A and 9B are perspective views showing a cleaning arm and a nozzle set according to other exemplary embodiments of the present general inventive concept.

Referring to FIG. 9A, a photomask cleaning apparatus 230a may comprise a main cleaning arm 231M, a left cleaning arm 231L and a right cleaning arm 231R. The left cleaning arm 231L may be located in a left side with respect to the main cleaning arm 231M when viewed from the main cleaning arm 231M. The right cleaning arm 231R may be located in a right side with respect to the main cleaning arm 231M when viewing the main cleaning arm 231M. The left cleaning arm 231L and the right cleaning arm 231R may each have two nozzle sets 350L and 350R, respectively.

The left and right nozzle sets 350L and 350R may be understood in detail by referring to FIG. 5A. The photomask cleaning apparatus 230a may simultaneously clean two regions of a photomask using the left and right nozzle sets 350L and 350R.

Referring to FIG. 9B, a photomask cleaning apparatus 230b may comprise a back cleaning arm 231B, a front cleaning arm 231F, a left cleaning arm 231L, a main cleaning arm 231M and a right cleaning arm 231R. The back cleaning arm 231B may be located in a back side with respect to the left and right cleaning arms 231L and 231R when viewing the figure while front arm 231F may be located in a front side with respect to the left and right cleaning arms 231L and 231R when viewing the figure. That is, the back cleaning arm 231B and the front cleaning arm 231F extend in the negative and positive Y axis directions, respectively, the left cleaning arm 231L and the right cleaning arm 231R extend in the negative and positive X axis directions, respectively, and the X and Y axis directions are substantially perpendicular to each other.

The back cleaning arm 231B and the front cleaning arm 231F may have two nozzle sets 350B and 350F, respectively. The left and right cleaning arms 231L and 231R may have the same shape as that shown in FIG. 9a. Each of the nozzle sets 350B, 350F, 350L and 350R may be understood in detail by referring to FIG. 5A.

The photomask cleaning apparatus 230b may simultaneously clean four regions of a photomask using the nozzle sets 350B, 350F, 350L and 350R. Meanwhile, the exemplary embodiments of photomask cleaning apparatuses 230a and 230b of FIGS. 9A and 9B may be combined with, and applied to the exemplary embodiments of photomask cleaning apparatuses 10a to 10d of FIGS. 1 to 4.

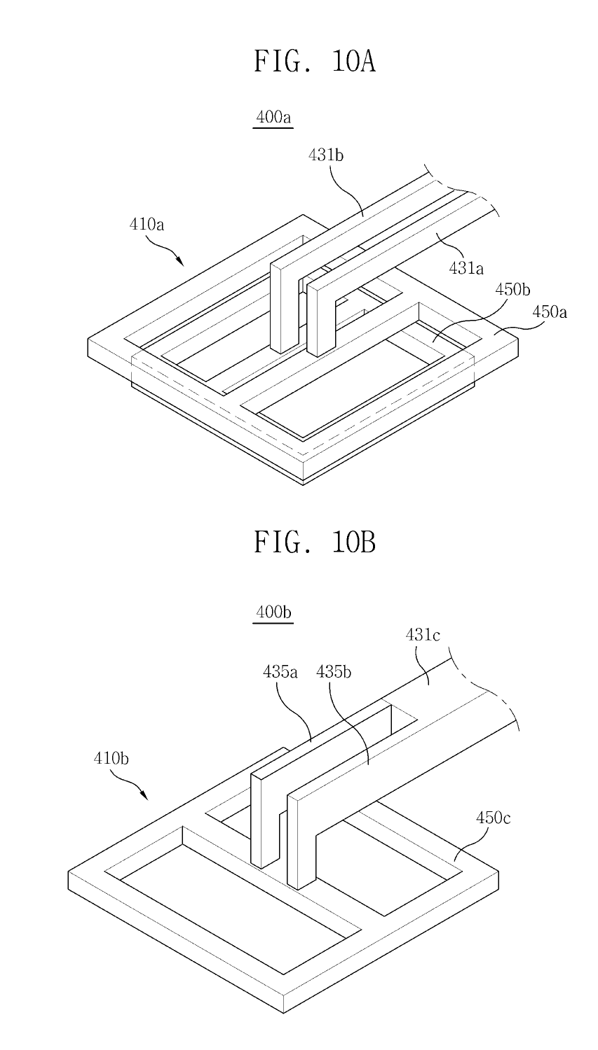

FIGS. 10A and 10B are perspective views showing a cleaning arm and a nozzle set according to other exemplary embodiments of the present general inventive concept.

Referring to FIG. 10A, a photomask cleaning apparatus 400a may comprise a nozzle set 410a, a first cleaning arm 431a and a second cleaning arm 431b. The nozzle set 410a may comprise a first nozzle 450a and a second nozzle 450b. The respective first and second nozzles 450a and 450b may comprise a frame shape.

The first cleaning arm 431a may be connected to the first nozzle 450a and the second cleaning arm 431b may be connected to the second nozzle 450b. The first nozzle 450a may be larger in scale than the second nozzle 450b and the first nozzle 450a may be located lower than the second nozzle 450b. However, the positional relationship of the first and second nozzles 450a and 450b are not limited to such arrangements.

The first and second nozzles 450a and 450b may be combined and applied to the various exemplary embodiments shown in FIGS. 1 to 4 and may supply a fluid in various shapes. Further, for example, the first nozzle 450a may spray a liquid on a photomask, and the second nozzle 450b may spray air on the photomask.

Referring to FIG. 10B, a photomask cleaning apparatus 400b may comprise a nozzle set 410b and cleaning arms 431c, 435a and 435b. The nozzle set 410a may comprise a nozzle 450c. The nozzle 450c may comprise at least two spray openings and may simultaneously spray at least two fluids through the at least two spray openings. The nozzle 450c may be understood by further referring to FIGS. 5B, 8A and 8B.

The nozzle 450c may be supported by the cleaning arms 431c, 435a and 435b. The cleaning arms 431c, 435a and 435b may be in one body or separate from one another as shown in FIG. 10B. That is, only the cleaning arm 431c may be connected to the nozzle 450c. In this case, the cleaning arm 431c may have the same shape as or a different shape from the cleaning arm 435b on the nozzle 450c.

The cleaning arms 435a and 435b may be connected to the nozzle 450c. The cleaning arms 435a and 435b may be attachable to and detachable from each other. The cleaning arm 435b may have the same shape as or a different shape from the cleaning arms 431c outside the nozzle 450c. The cleaning arms 435a and 435b may support the nozzle 450c through one of them and may supply a fluid through the remaining one of them.

The cleaning arms 435a and 435b may supply a first fluid through one of them and a second fluid through the remaining one of them.

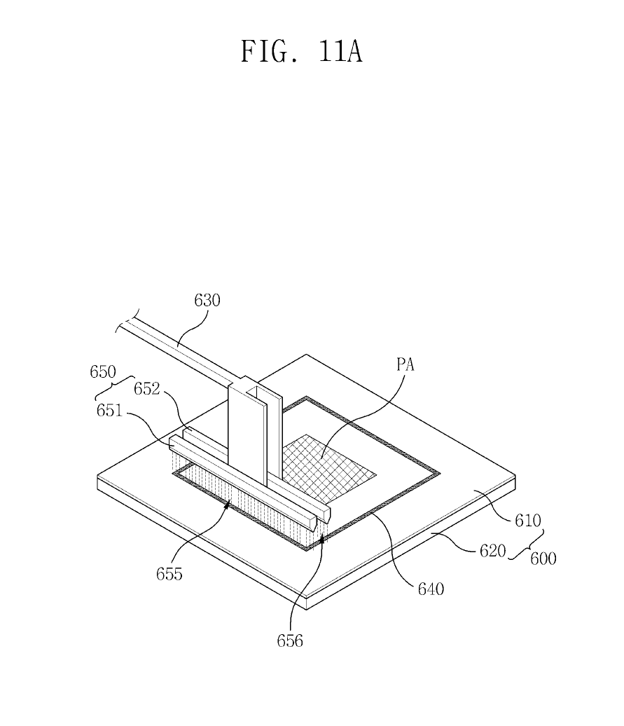

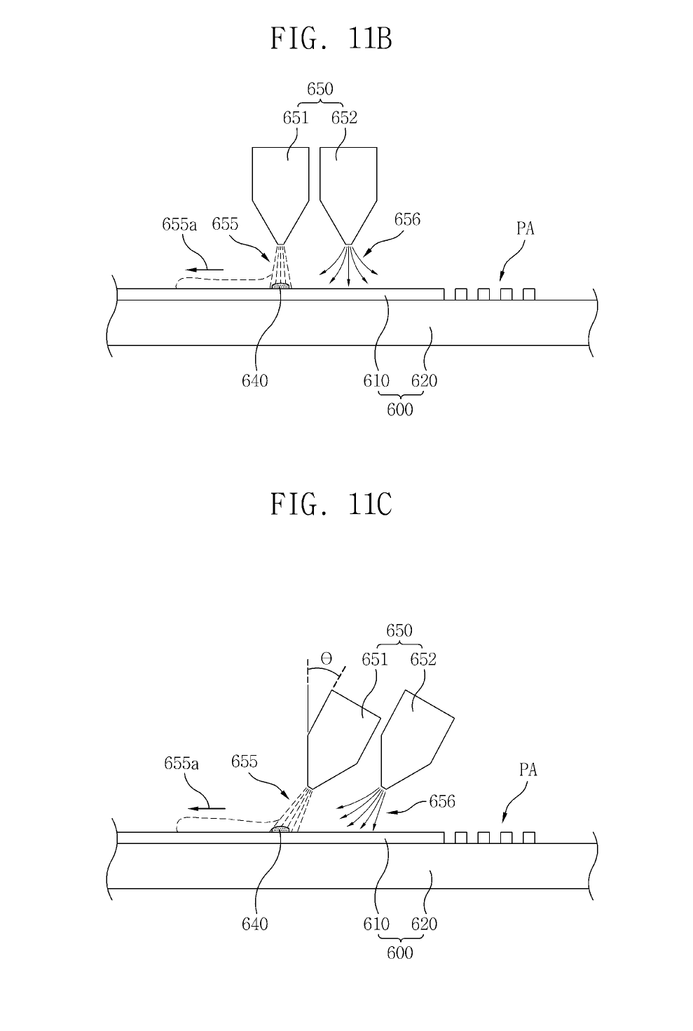

FIGS. 11A to 11C are schematic views illustrating a method of cleaning a photomask using a photomask cleaning apparatus according to exemplary embodiments of the present general inventive concept.

Referring to FIG. 11A, during the cleaning of a photomask 600, a pellicle (not shown) may be detachable from the photomask 600. The photomask 600 may comprise an opaque layer 610, a transparent layer 620 and an optical pattern area PA. After the detachment of the pellicle from the photomask 600, a contaminant 640 of the pellicle may remain on the photomask 600. The contaminant 640 may be an adhesive or a glue of the pellicle.

The contaminant 640 may be located adjacent to the optical pattern area PA. Then the photomask 600 may be placed under a nozzle set 650. The nozzle set 650 may comprise a first nozzle 651 and a second nozzle 652. The first nozzle 651 and the second nozzle 652 may spray a first fluid 655 and a second fluid 656 through a cleaning arm 630, respectively. The first fluid 655 may be a cleaning solution, and the second fluid 656 may be air. The nozzle set 650 may remove the contaminant 640 from the photomask 600 by using the first and second nozzles 651 and 652.

Referring to FIG. 11B, the first nozzle 651 may be located farther than the second nozzle 652 from the optical pattern area PA to spray the first fluid 655 on the contaminant 640. In other words, during operation, the first nozzle 651 encounters the contaminant 640 prior to the second nozzle 652 encountering the contaminant 640. The second nozzle 652 may be located between the contaminant 640 and the optical pattern area PA to spray the second fluid 656 on the photomask 600.

In this case, the second fluid 656 may allow the first fluid 655 to flow toward a distant direction 655a from the optical pattern area PA. That is, the second fluid 656 may force the first fluid 655 away from the optical pattern area PA. This is because a portion of the stream or current of the second fluid 656 pushes the first fluid 655 out to the distant direction 655a. Accordingly, because the optical pattern area PA is not influenced by the first fluid 655, the optical pattern area PA may be free from additional contamination through the first fluid 655.

Referring to FIG. 11C, during the spraying of the first and second fluids 655 and 656, the first and second nozzles 651 and 652 may be inclined with respect to a surface of the photomask 600.

As such, the first fluid 655 may be effectively prevented from flowing into the optical pattern area PA due to the second fluid 656. Alternatively, one of the first and second nozzles 651 and 652 may be inclined with respect to the photomask 600, while the other is not inclined with respect to the photomask 600.

As described above, a photomask cleaning apparatus according to exemplary embodiments of the present general inventive concept remove a contaminant while preventing damage to an optical pattern region of the photomask so as to clean only a specific region of the photomask. Accordingly, the life span of the photomask may be extended through the photomask cleaning apparatus. Production cost of the photomask may be reduced by minimizing the use of a cleaning solution. Also, fabrication process of the photomask may be eco-friendly due to the minimum use of the cleaning solution.

Although a few exemplary embodiments of the present general inventive concept have been shown and described, it will be appreciated by those skilled in the art that changes may be made in these embodiments without departing from the principles and spirit of the present general inventive concept, the scope of which is defined in the appended claims and their equivalents.

What is claimed is:

1. A photomask cleaning apparatus comprising:
a photomask chuck;
a cleaning arm; and
a nozzle set including at least first and second nozzles installed in an end portion of the cleaning arm, the at least first and second nozzles are a bar-type shape and substantially parallel to each other.

2. The photomask cleaning apparatus of claim 1, wherein the first nozzle includes a first outer case and a first inner tube, and the second nozzle includes a second outer case and a second inner tube.

3. The photomask cleaning apparatus of claim 2, wherein the first outer case has a first slit thereon.

4. The photomask cleaning apparatus of claim 3, wherein the first outer case has at least two guiders in a lower portion thereof defining the first slit.

5. The photomask cleaning apparatus of claim 2, wherein each of the first inner tube and the second inner tube has a plurality of holes thereon.

6. The photomask cleaning apparatus of claim 1, wherein the first nozzle sprays a liquid, and the second nozzle sprays a gas.

7. The photomask cleaning apparatus of claim 6, wherein the liquid includes at least one of a sulfuric acid solution, a hydrogen peroxide solution, an ammonia solution, a nitric acid solution, a hydrofluoric acid solution, a hydrochloric acid solution, an acetone, alcohol, a solvent, and water.

8. The photomask cleaning apparatus of claim 1, wherein the first nozzle is greater in length than the second nozzle.

9. The photomask cleaning apparatus of claim 1, further comprising:
a fluid-supplying path supplying the nozzle set with a fluid.

10. The photomask cleaning apparatus of claim 9, wherein the fluid-supplying path includes a first fluid-supplying path and a second fluid-supplying path, and the first fluid-supplying path and the second fluid-supplying path are connected to the first nozzle and the second nozzle, respectively.

11. The photomask cleaning apparatus of claim 10, wherein the first fluid-supplying path supplies a liquid to the first nozzle, and the second fluid-supplying path supplies a gas to the second nozzle.

12. The photomask cleaning apparatus of claim 9, wherein the fluid-supplying path is installed in the interior of the cleaning arm.

13. The photomask cleaning apparatus of claim 1, wherein at least one of the first nozzle and the second nozzle is inclined with respect to a surface of the photomask chuck.

14. A photomask cleaning apparatus comprising:
a photomask chuck;
a cleaning arm;
a nozzle set including at least two nozzles each having a liquid-spraying nozzle and an gas-spraying nozzle installed in an end portion of the cleaning arm, the liquid-spraying nozzle and the gas-spraying nozzle being substantially parallel to each other and inclined with respect to a surface of the photomask chuck.

15. The photomask cleaning apparatus of claim 14, wherein each of the liquid-spraying and gas-spraying nozzles includes an inner tube and an outer case, the inner tube includes a plurality of holes, the outer case includes guiders in a lower portion thereof, and the guiders define a slit therebetween.

16. A photomask cleaning apparatus configured to clean a surface of a photomask, the apparatus comprising:
a cleaning arm; and
a first nozzle set including at least a first nozzle and a second nozzle installed in an end portion of the cleaning arm.

17. The photomask cleaning apparatus of claim 16, wherein the first and second nozzles of the first nozzle set are bar-type shaped and substantially parallel to each other.

18. The photomask cleaning apparatus of claim 16, wherein the first nozzle includes a first outer case having at least two guiders defining a first slit therein and a first inner tube having a plurality of holes formed therein, and
the second nozzle includes a second outer case having at least two guiders defining a second slit therein and a second inner tube having a plurality of holes formed therein.

19. The photomask cleaning apparatus of claim 16, wherein at least one of the first and second nozzles is inclined with respect to the surface of a photomask.

20. The photomask cleaning apparatus of claim 16, further comprising:
a second nozzle set including at least a third nozzle and a fourth nozzle installed in the end portion of the cleaning arm;
a third nozzle set including at least a fifth nozzle and a sixth nozzle installed in the end portion of the cleaning arm; and
a fourth nozzle set including at least a seventh nozzle and an eighth nozzle installed in the end portion of the cleaning arm, wherein the first nozzle set is substantially parallel to the second nozzle set and the third nozzle set is substantially parallel to the fourth nozzle set, the first and second nozzle sets being substantially perpendicular to the third and fourth nozzle sets.
